(19) United States
(12) Patent Application Publication
(10) Pub. No.: US 2014/0181909 A1
(43) Pub. Date: Jun. 26, 2014

(54) SYSTEM AND METHOD FOR SECURED ACCESS MANAGEMENT

(71) Applicants: ERAN BIRK, Haifa (IL); DAN SHMUL, Binyamina (IL); REUT REUVENI, Haifa (IL)

(72) Inventors: ERAN BIRK, Haifa (IL); DAN SHMUL, Binyamina (IL); REUT REUVENI, Haifa (IL)

(21) Appl. No.: 13/725,057

(22) Filed: Dec. 21, 2012

(51) Int. Cl. H04L 29/06

(52) U.S. Cl. CPC H04L 63/10
USPC 726/4

(57) ABSTRACT

A system and method for managing secure access to one or more applications and data provided via the application based on trustworthiness of a client device. The system is configured to establish a level of trustworthiness of the client device based, at least in part, on attributes of the client device and the user of the client device. In the event that the level of trustworthiness meets or exceeds a predefined trust level for a corresponding application, the system is configured to authorize and allow the client device to execute the application and access data provided via the application. Alternatively, in the event that the level of trustworthiness falls below a predefined trust level, the system is configured to restrict execution of the application and/or access to data provided via the application.

### FIELD

The present disclosure relates to information security, and, more particularly, to a system and method for managing secure access to an application and data provided by the application based on trustworthiness of a client device.

### BACKGROUND

With ongoing advances in technology, consumers have greater variety and more flexibility in the technology that they use in their everyday lives. This may include more powerful mobile devices and electronics as well as applications (e.g. email, social networks, etc.) providing consumers with the means to interact and share information with one another. As information technology (IT) expands and develops in the consumer markets, it may spread to business and government organizations, a trend sometimes referred to as the consumerization of IT.

The consumerization of IT (hereinafter referred to as “consumerization”) is generally understood to refer to the blending of personal and business use of technology devices and applications. For example, employees may wish to use the same technology at both home and work, and, as such, will introduce consumer market technologies into the workplace which may utilize enterprise software. Some businesses may allow, and even encourage, a policy known as bring your own device (BYOD) (also known as bring your own technology (BYOT)), in which employees bring personally-owned devices to their place of work and use those devices, as well as software included on the device (e.g. cloud computing applications (e.g. Google Drive, DropBox), web browser, media player, etc.) to access company resources, such as email, file servers and databases, by way of, for example, the business's enterprise software.

Although the use of consumer technology in the workplace may offer potential benefits for a business, such as greater flexibility, increased productivity and the like, consumerization also represents added risk in terms of security, privacy, and compliance. In particular, the use of more types of devices, more services and more mechanisms of exchanging information may result in a greater risk of security breaches. This may be particularly true with regard to accessing and exchanging confidential data of the business by way of personal consumer devices and software. Personal devices may be less trustworthy and may expose business IT equipment, infrastructure (e.g. directory) and services to a variety of security breaches, such as, for example, malicious attackers obtaining confidential data, malicious viruses, worms, spyware, Trojan horse programs, and other similar threats.

As such, consumerization has had a large impact on businesses, particularly the manner in which a business will plan on procuring and managing IT equipment and services, while keeping consumerization in mind. In one instance, a business may institute a policy of forbidding employees from consuming IT services on their personal devices, thereby hoping to completely prevent consumerization in order to prevent the risks associated with consumerization. However, in addition to foregoing the benefits associated with consumerization, a business may find it difficult to obtain complete employee compliance, wherein employees may ignore and break the rules by synchronizing business information into their personal device which may expose the business to security risks. In another instance, rather than completely preventing consumerization, a business may embrace the use of personal devices in the workplace which may benefit the business, but will potentially expose the business to the associated risks due to unsecured personal devices.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for managing secure access to one or more applications based on trustworthiness of a client device consistent with the present disclosure;

FIG. 2 is a block diagram illustrating the system of FIG. 1 in greater detail;

FIG. 3 is a block diagram illustrating another embodiment of the system of FIG. 1 in greater detail;

FIG. 4 is a block diagram illustrating one embodiment of a trust service module consistent with various embodiments of the present disclosure; and

FIG. 5 is a flow diagram illustrating one embodiment for managing secure access to an application consistent with present disclosure.

### DETAILED DESCRIPTION

By way of overview, the present disclosure is directed to a system and method for managing secure access to one or more applications and associated data based on trustworthiness of a client device. A system consistent with the present disclosure is configured to authorize a client device secure access to an application and associated data based on a level of trustworthiness of the client device. The level of trustworthiness is based, at least in part, on attributes of the client device and the user of the client device, including, but not limited to, the type of client device, the operating system (OS) of the client device, state of privileged escalation on the client device, identity of the user, location of the user, etc. In the event that the level of trustworthiness meets or exceeds a predefined trust level for a corresponding application, the system is configured to authorize and allow the client device to execute the application and access data provided via the application. Alternatively, in the event that the level of trustworthiness falls below a predefined trust level, the system is configured to restrict execution of the application and/or access to data provided via the application.

A system consistent with the present disclosure is configured to determine the trustworthiness of each user device and provide secure access to applications, independent of the type of device, and deliver those applications in a way that respects device form factor and purpose. The system is further configured to secure consumer devices running the applications and the data being shared via those applications. Accordingly, a system consistent with the present disclosure is configured to allow integration of personal devices into the workplace while providing enhanced information security, particularly for businesses embracing consumerization.

A system consistent with the present disclosure enables productivity while also protecting business information by focusing on the use of applications on personal user devices in the business setting. Generally, it is the ability to run applications on consumer devices that drives the additional productivity offered by consumerization. Accordingly, a system consistent with the present disclosure is configured to provide secure access to applications and the data shared via those applications across a diverse set of employee-owned devices, alongside business-owned systems, thereby enabling increased productivity while ensuring enhanced information security. As such, a system consistent with the present disclosure may allow employees to have a highly personal, highly productive user experience without sacrificing the security of their company information.

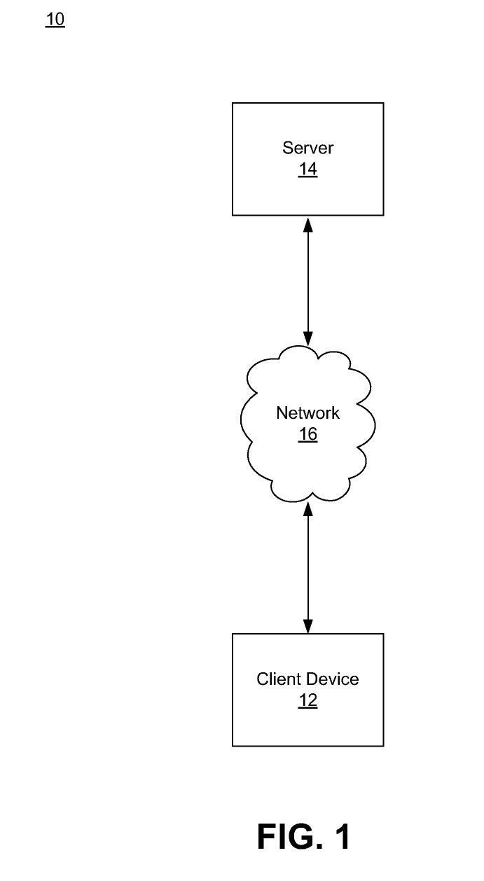

Turning to FIG. 1, one embodiment of a system 10 consistent with the present disclosure is generally illustrated. The system 10 includes a client device 12 configured to communicate with a server 14 over a network 16. As discussed in greater detail herein, the server 14 may be generally be associated with a back end system of a business or corporation, for example. As generally understood, a back end system may be used to run a company, effectively supporting the company's back office, collecting input from users or other systems for processing. As such, the server 14 may include servers, superservers, clustered systems, midrange systems, and mainframes that provide data services to users. Although the illustrated embodiment includes a single server 14, a system consistent with the present disclosure may include server farm or data center, including a plurality of servers.

The client device 12 may be configured to access data and services, as well as applications provided by the server 14 via the network 16. The network 16 may be any network that carries data. Non-limiting examples of suitable networks that may be used as network 16 include the internet, private networks, virtual private networks (VPN), public switch telephone networks (PSTN), integrated services digital networks (ISDN), digital subscriber link networks (DSL), wireless data networks (e.g., cellular phone networks), other networks capable of carrying data, and combinations thereof. In some embodiments, network 16 is chosen from the internet, at least one wireless network, at least one cellular telephone network, and combinations thereof.

As generally understood, the client device 12 may include a personal device generally used for personal use. However, the user may desire to bring the client device 12 into the work environment for business-related use. The client device 12 may include, but is not limited to, a mobile telephones, smartphones (e.g., iPhones®, Android®-based phones, Blackberries®, Symbian®-based phones, Palm®-based phones, etc.), tablet computers, notebook computers, ultraportable computers, ultramobile computers, netbook computers, subnotebook computers, personal digital assistants, enterprise digital assistants, mobile internet devices and personal navigation devices. Small form factor (SFF) devices, a subset of mobile devices, typically include hand-held mobile devices (i.e., hand-held devices with at least some computing capability).

The computing environment between the client device 12 and server 14 may split processing between a front-end application that runs on the client device 12 and back-end services running on the server 14, communicating with one another via the network 16. Some back-end services may include database management systems (DBMSs), messaging systems (i.e., Lotus Notes and Microsoft Exchange), gateways to legacy systems and network management systems of the corporation. A user may interact with applications on the client device 12 to make requests on the server 14. The server 14 may then process the requests, searching and sorting data, serving up files, and providing other services.

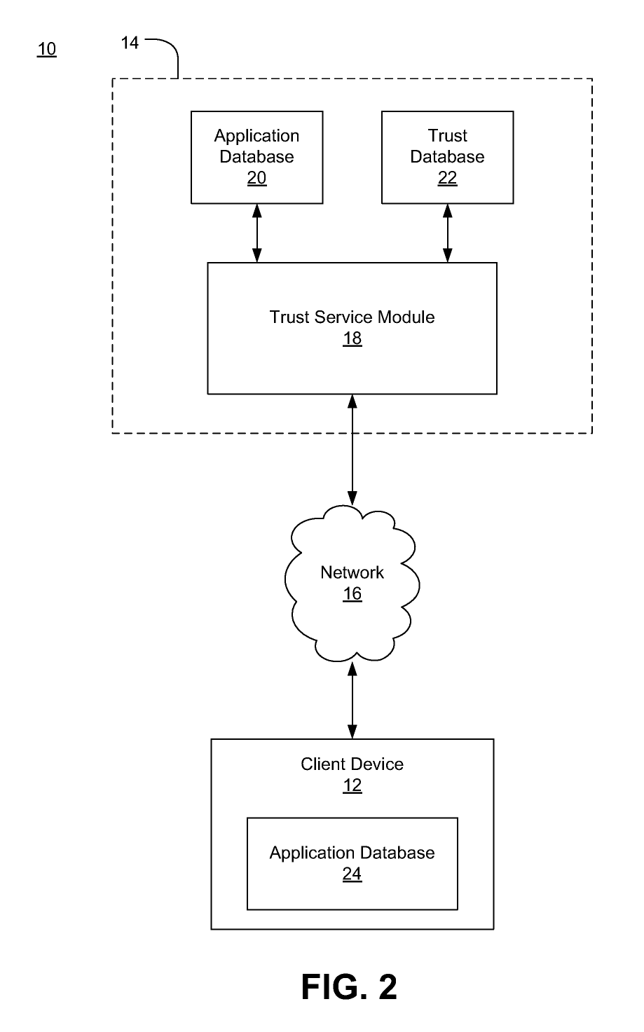

Turning now to FIG. 2, the system of FIG. 1 is illustrated in greater detail. A system consistent with the present disclosure may provide a variety of application delivery mechanisms. For example, as shown, the server 14 may include an application database 20. In one embodiment, the client device 12 may be configured to access the server 14 via the network 16 and gain access to one or more applications stored in the application database 20 of the server 14. More specifically, applications are generally stored in the application database 20 of the server 14, where processing takes place, and the applications are accessed from the server 14. As shown, the client device 12 may also include an application database 24 in which the client device 12 may be configured to access and execute applications locally, and communicate with the server 14 to access data stored on the server 14 via the running application. It should be noted that, in addition to the application delivery mechanisms described above, the system 10 may also provide other known means of application delivery, including, but not limited to, streamed to server, streamed to client device and dual mode delivery.

As generally understood, the applications described herein generally refer to any known application software, generally designed to help a user perform specific tasks. Applications may include, but are not limited to, enterprise software (e.g. financial systems, customer relationship management (CRM) systems, etc.), accounting software, office suites (e.g. Microsoft Office, iWork, etc.), graphics software and media players (iTunes, Windows Media Player, etc.). As described above, the delivery of applications can vary, particularly depending on the application type. For example, the system 10 may be configured to handle and deliver a variety of different application types, including, but not limited to, container applications (which consists of several applications that are wrapped under a shell that encrypts the content of the applications), wrapper of an application (a single application shell that encrypts the content and application) and hybrid application (an application that is partially built as native on the OS of the client device 12 and partially on the back end system (i.e. server 14).

In one embodiment, a client device 12 may attempt to access and execute enterprise software applications. As generally understood, enterprise application software is configured to performs business functions such as order processing, procurement, production scheduling, customer information management, energy management, and accounting and may be hosted on servers (e.g. server 14) and provide simultaneous services to a large number of client devices over the network 16.

The server 14 may also include a trust service module 18 configured to detect the presence of the client device 12, particularly detecting the client device communicating with the server 14 via the network 16, attempting to execute an application and access data provided therewith. The trust service module 18 is configured to identify one or more characteristics of the client device 12 (as well as characteristics of the associated user) and provide identified characteristics to a trust database 22, thereby creating a client device profile stored therein. The trust service module 18 is further configured to establish a level of trustworthiness of the client device 12 (and associated user) based on the identified characteristics and determine whether the client device 12 and user are authorized to execute the application and access data provided with the application based on the level of trustworthiness.

In the event that the level of trustworthiness meets or exceeds a predefined trust level for a corresponding application, the trust service module 18 is configured to authorize and allow the client device 12 to execute the application and access data provided via the application. Alternatively, in the event that the level of trustworthiness falls below a predefined trust level, the trust service module 18 is configured to restrict execution of the application and/or access to data provided via the application.

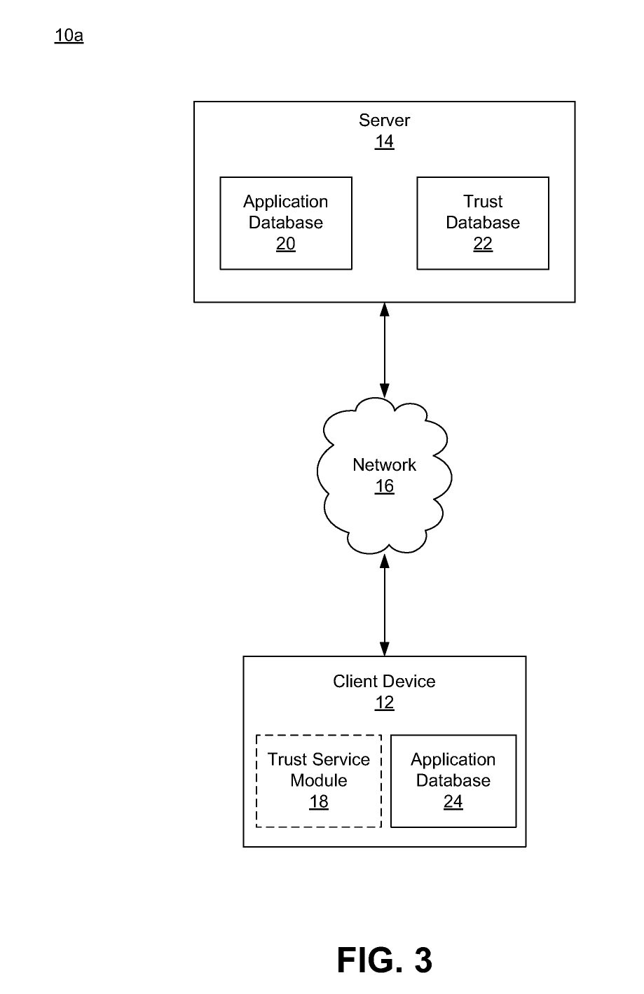

In the illustrated embodiment of FIG. 2, the trust service module 18 is included in the server 14, as part of the back end system for a corporation. It should be noted that in other embodiments, as generally understood by one skilled in the art, the trust service module 18 may optionally be included within the client device 12 itself, as shown in FIG. 3, for example. The optional inclusion of the trust service module 18 as part of the client device, rather than an element external to client device 12, is denoted in FIG. 3 with broken lines.

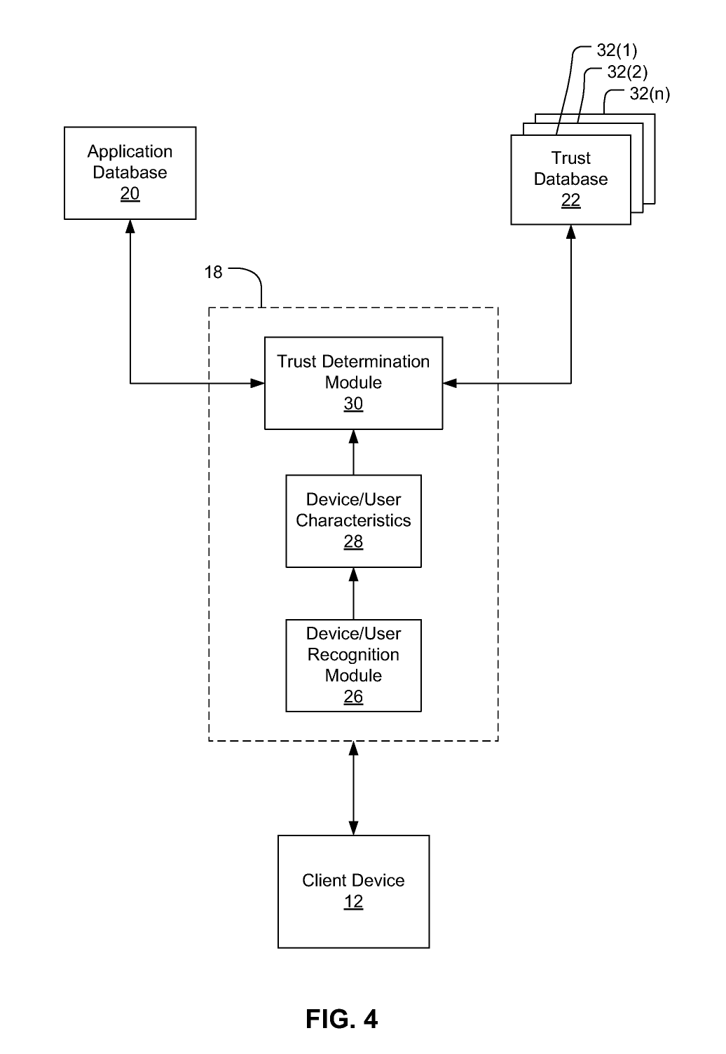

Turning now to FIG. 4, one embodiment of a trust service module 18 consistent with various embodiments of the present disclosure is illustrated. As shown, the trust service module 18 includes a device/user recognition module 26. When the client device 12 is communicatively coupled to the server 14 via the network 16 and, in some instances, attempting to execute an application, the device/user recognition module 26 is configured to analyze the client device 12 and determine one or more characteristics of the client device 12 and associated user (i.e. device/user characteristics 28). For example, the device/user recognition module 26 may be configured to identify attributes of the client device 12, such as, for example, the device type (e.g. notebook computer, tablet, smartphone, etc.) and operating system (OS) of the device. The device/user recognition module 26 may also identify attributes of the user of the client device 12, such as, for example, the identity of the user (via any known user name and password query process), which may include the role of the user (e.g. title and position within the corporation). As generally understood, the device/user recognition module 26 may include custom, proprietary, known and/or after-developed device recognition and characteristics code (or instruction sets), hardware, and/or firmware that are generally well-defined and operable to receive client device data and identify common and unique attributes of a client device and the associated user.

The device/user characteristics 28 may be generated based on the attributes of the client device 12 and/or associated user identified by the device/user recognition module 26. The device/user characteristics 28 may include, but are not limited to, common attributes of the device (e.g. device type, OS, OS version), unique attributes of the device (e.g. media access control (MAC) address, international mobile station equipment identity (IMEI), universal device identifier (UDI), certificate status (whether the device has an installed and active certificate), encryption level (via mobile device management (MDM) records), state of privileged escalation (e.g. jailbreak for iOS and root access for Android)), device location and user attributes (e.g. user identity, including the user's role within the corporation and associated credentials).

The trust service module 18 may be configured to transmit the generated device/user characteristics 28 to the trust database 22 of the server 14, wherein a client device profile 32 is created, and includes the device/user characteristics 28. The trust database 22 may include a plurality of client device profiles 32(1)-32(n), each corresponding to a client device that is currently or has previously attempted to access applications and the data provided therewith. The trust service module 18 further includes a trust determination module 30 configured to establish a level of trustworthiness of the client device 12 based on the corresponding client device profile 32 from the trust database 22 and the device/user characteristics 28 associated therewith.

For example, the trust determination module 30 may include custom, proprietary, known and/or after-developed trust level code (or instruction sets), hardware, and/or firmware that are generally well-defined and operable to receive client device data (device/user characteristics 28) and establish a level of trustworthiness of the client device based on the data. The level of trustworthiness of a client device may generally be greater if the device/user attributes 28 generally correspond to higher level of security, thereby indicating less potential risk to sensitive corporate data and information. For example, in one embodiment, the level of trustworthiness may be generally high if a client device profile 32 indicates that the client device includes the most up-to-date version of an OS (such as Android), is in a non-rooted state, includes an installed and active certificate and MDM records indicating high level of encryption and the user has provided a one-time password (OTP) for access to a specific application. In another embodiment, the level of trustworthiness may be generally low if the client profile 32 indicates that the client device does not include the most up-to-date version of the OS, is in a rooted access (or jailbreak) state, or does not include an installed and active certificate, etc.

Accordingly, the trust determination module 30 is configured to calculate a level of trustworthiness for each client device profile 32(1)-32(n) stored in the trust database 22. The level of trustworthiness may be expressed as a value ranging from 0 (lowest level of trust) to 5 (highest level of trust). It should be noted that the range of values may be greater (e.g. 0 to 10, 0 to 50, etc.) depending on the information security policy of the corporation and the desired range and accessibility of applications.

As described in greater detail herein, each application may have a specific security policy associated therewith and, as such, each application may include a corresponding predefined application trust level. The execution of certain applications may expose confidential data and information. As such, in order for a client device to execute an application, the client device may be required to have a level of trustworthiness that meets or exceeds the application trust level of any particular application. Each application may have a different trust level associated therewith depending on the desired level of security. For example, an application that may expose highly confidential information may have a correspondingly high application trust level. Alternatively, an application that may expose relatively minor confidential information, if any, may have a correspondingly low application trust level.

Upon calculating the level of trustworthiness of the client device 12, the trust determination module 30 is configured to identify an application that the client device 12 is attempting to execute and further identity the application trust level associated with the application. The trust determination module 30 is further configured to compare the level of trustworthiness of the client device 12 with the application trust level. If the level of trustworthiness meets or exceeds the application trust level value, the trust determination module 30 determines that the client device 12 is authorized to execute the application and access data provided via the application. Alternatively, if the level of trustworthiness is below the application trust level value of the application, the trust determination module 30 determines that the client device 12 is not authorized to execute the application and further restricts execution of the application by the client device 12.

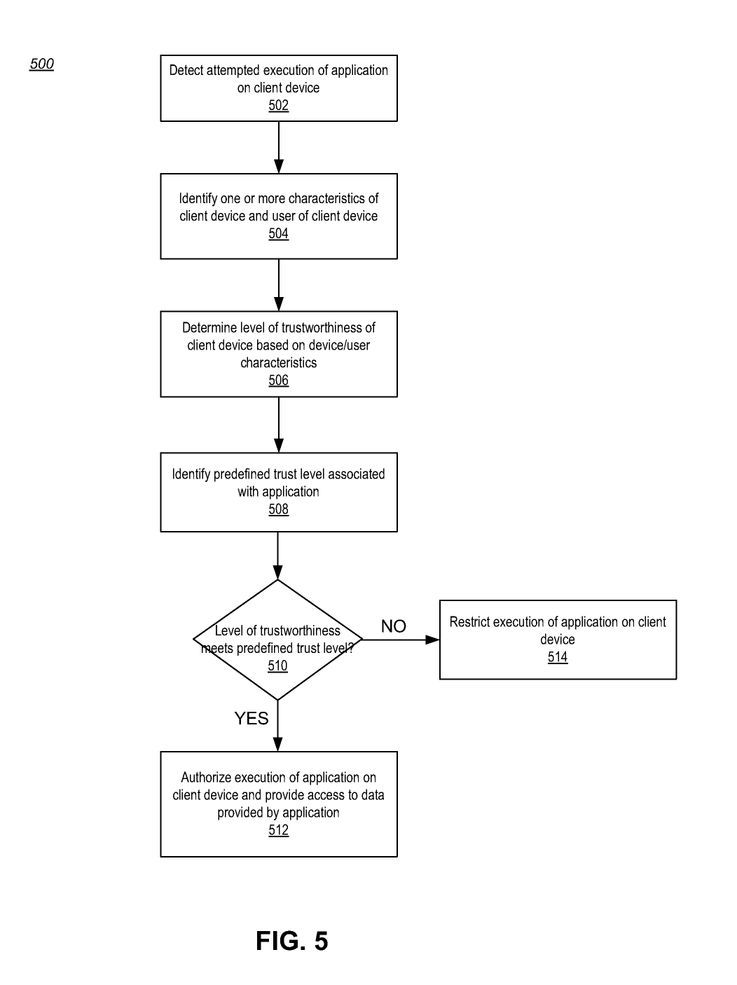

Turning now to FIG. 5, a flowchart of one embodiment of a method 500 for managing secure access to an application consistent with the present disclosure is illustrated. The method 500 includes detecting an attempted execution of an application on a client device (operation 502). In particular, the client device will be detected and the application that the user intends on launching is identified just prior to fully executing the application. This may take place on the first initiation of the application and on each subsequent attempt of launching the application. The method 500 further includes identifying one or more characteristics of the client device and the user of the client device (operation 504). The characteristics include, but are not limited to, the type of client device, the operating system (OS) of the client device, state of privileged escalation on the client device, identity of the user, location of the user, etc.

The method 500 further includes determining a level of trustworthiness of the client device based on the device/user characteristics identified in operation 504 (operation 506). Each client device attempting to execute an application will have an associated level of trustworthiness calculated based on attributes of that particular client device and associated user. The method further includes identifying a predefined trust level associated with the application that the user attempted to execute in operation 502 (operation 508). The application trust level may be defined by a specific security policy based on the level of desired confidentiality of the information that may be exposed by execution of the application. For example, an application providing access to highly valuable and confidential information may have a correspondingly high application trust level.

A determination may then be made in operation 510 as to whether the level of trustworthiness of the client devices meets the predefined trust level of the application. If it is determined that the level of trustworthiness meets or exceeds the predefined trust level of the application, then the client device is authorized to execute the application and gain access to data provided by the application (operation 512). If it is determined that the level of trustworthiness does not meet the predefined trust level of the application, then the client device is restricted from executing the application (operation 514).

While FIG. 5 illustrates method operations according various embodiments, it is to be understood that in any embodiment not all of these operations are necessary. Indeed, it is fully contemplated herein that in other embodiments of the present disclosure, the operations depicted in FIG. 5 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

According to one aspect of the present disclosure, there is provided an apparatus for managing secure access to an application and data provided by the application. The apparatus includes a device recognition module configured to analyze a client device attempting to access an application and identify one or more characteristics of the client device and an associated user. The apparatus further includes a trust determination module configured to establish a level of trustworthiness of the client device based on the identified one or more characteristics and to determine the client device is authorized to execute the application and access associated data based on a comparison of level of trustworthiness of the client device with a predefined level of trust of the application.

Another example apparatus includes the foregoing components and if the level of trustworthiness is greater than or equal to the level of trust of the application, the trust determination module is configured to authorize and allow the client device to execute the application and access associated data.

Another example apparatus includes the foregoing components and if the level of trustworthiness is less than the level of trust of the application, the trust determination module is configured to prevent the client device from executing the application and accessing the associated data.

Another example apparatus includes the foregoing components and the one or more identified characteristics comprise client device attributes and user attributes.

Another example apparatus includes the foregoing components and the client device attributes are selected from the group consisting of client device type, operating system (OS), media access control (MAC) address, international mobile station equipment identity (IMEI), universal device identifier (UDI), certificate status, encryption level by way of mobile device management (MDM) records and state of privileged escalation.

Another example apparatus includes the foregoing components and the user attributes are selected from the group consisting of user identity, user credentials and user role.

Another example apparatus includes the foregoing components and the client device is a personal electronic computing device and the application includes enterprise application software configured to provide the client device with access to data stored within a back end system of a business.

Another example apparatus includes the foregoing components and the client device is selected from the group consisting of mobile telephone, smartphone, tablet computer, notebook computer, ultraportable computer, ultramobile computer and netbook computer.

According to another aspect of the present disclosure, there is provided a system for managing secure access to an application and data provided by the application. The system includes a server having data stored thereon, a client device configured to communicate with the server over a network and a trust service module configured to detect an attempted execution of an application on the client device to access the data on the server and manage access of the data on the client device. The trust service module includes a device recognition module configured to analyze the client device attempting to access the application and identify one or more characteristics of the client device and an associated user. The trust service module further includes a trust determination module configured to establish a level of trustworthiness of the client device based on the identified one or more characteristics and to determine the client device is authorized to execute the application and access the data of the server based on a comparison of level of trustworthiness of the client device with a predefined level of trust of the application.

Another example system includes the foregoing components and if the level of trustworthiness is greater than or equal to the level of trust of the application, the trust determination module is configured to authorize and allow the client device to execute the application and access the data on the server.

Another example system includes the foregoing components and if the level of trustworthiness is less than the level of trust of the application, the trust determination module is configured to prevent the client device from executing the application and accessing the data on the server.

Another example system includes the foregoing components and the one or more identified characteristics comprise client device attributes and user attributes.

Another example system includes the foregoing components and the client device attributes are selected from the group consisting of client device type, operating system (OS), media access control (MAC) address, international mobile station equipment identity (IMEI), universal device identifier (UDI), certificate status, encryption level by way of mobile device management (MDM) records and state of privileged escalation.

Another example system includes the foregoing components and the user attributes are selected from the group consisting of user identity, user credentials and user role.

Another example system includes the foregoing components and the client device is a personal electronic computing device and the application includes enterprise application software configured to provide the client device with access the data stored on the server, wherein the server is associated with a back end system of a business.

Another example system includes the foregoing components and the client device is selected from the group consisting of mobile telephone, smartphone, tablet computer, notebook computer, ultraportable computer, ultramobile computer and netbook computer.

According to another aspect, there is provided at least one computer accessible medium including instructions stored thereon. When executed by one or more processors, the instructions may cause a computer system to perform operations for managing secure access to an application and data provided by the application. The operations include detecting an attempted execution of an application on a client device, identifying one or more characteristics of the client device and associated user of the client device, determining a level of trustworthiness of the client device based on the identified characteristics of the client device and associated user, identifying a predefined trust level associated with the application and comparing the level of trustworthiness of the client device with the trust level of the application and determining the client device is authorized to execute the application and access associated data based on the comparison.

Another example computer accessible medium includes the foregoing operations and further includes permitting execution of the application on the client device and allowing access to associated data if the level of trustworthiness is greater than or equal to the level of trust of the application.

Another example computer accessible medium includes the foregoing operations and further includes denying execution of the application on the client device and preventing access to associated data if the level of trustworthiness is less than the level of trust of the application.

According to another aspect of the present disclosure, there is provided a method for managing secure access to an application and data provided by the application. The method includes detecting, by a trust service module, an attempted execution of an application on a client device and identifying, by a device recognition module, one or more characteristics of the client device and associated user of the client device. The method further includes determining, by a trust determination module, a level of trustworthiness of the client device based on the identified characteristics of the client device and associated user and identifying, by the trust service module, a predefined trust level associated with the application. The method further includes comparing, by the trust determination module, the level of trustworthiness of the client device with the trust level of the application and determining the client device is authorized to execute the application and access associated data based on the comparison.

Another example method includes the foregoing operations and further includes permitting execution of the application on the client device and allowing access to associated data if the level of trustworthiness is greater than or equal to the level of trust of the application.

Another example method includes the foregoing operations and further includes denying execution of the application on the client device and preventing access to associated data if the level of trustworthiness is less than the level of trust of the application.

Another example method includes the foregoing operations and the one or more identified characteristics comprise client device attributes and user attributes.

Another example method includes the foregoing operations and the client device attributes are selected from the group consisting of client device type, operating system (OS), media access control (MAC) address, international mobile station equipment identity (IMEI), universal device identifier (UDI), certificate status, encryption level by way of mobile device management (MDM) records and state of privileged escalation.

Another example method includes the foregoing operations and the user attributes are selected from the group consisting of user identity, user credentials and user role.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present disclosure should not be limited by any of the above-described exemplary embodiments, but should be defined only in accordance with the following claims and their equivalents.

What is claimed is:

1. An apparatus for managing secure access to an application and data provided by the application, said apparatus comprising:
a device recognition module configured to analyze a client device attempting to access an application and identify one or more characteristics of said client device and an associated user; and
a trust determination module configured to establish a level of trustworthiness of said client device based on said identified one or more characteristics and to determine said client device is authorized to execute said application and access associated data based on a comparison of level of trustworthiness of said client device with a predefined level of trust of said application.

2. The apparatus of claim 1, wherein, if said level of trustworthiness is greater than or equal to said level of trust of said application, said trust determination module is configured to authorize and allow said client device to execute said application and access associated data.

3. The apparatus of claim 1, wherein, if said level of trustworthiness is less than said level of trust of said application, said trust determination module is configured to prevent said client device from executing said application and accessing said associated data.

4. The apparatus of claim 1, wherein said one or more identified characteristics comprise client device attributes and user attributes.

5. The apparatus of claim 4, wherein said client device attributes are selected from the group consisting of client device type, operating system (OS), media access control (MAC) address, international mobile station equipment identity (IMEI), universal device identifier (UDI), certificate status, encryption level by way of mobile device management (MDM) records and state of privileged escalation.

6. The apparatus of claim 4, wherein said user attributes are selected from the group consisting of user identity, user credentials and user role.

7. The apparatus of claim 1, wherein said client device is a personal electronic computing device and said application includes enterprise application software configured to provide said client device with access to data stored within a back end system of a business.

8. The apparatus of claim 7, wherein said client device is selected from the group consisting of mobile telephone, smartphone, tablet computer, notebook computer, ultraportable computer, ultramobile computer and netbook computer.

9. A system for managing secure access to an application and data provided by the application, said system comprising:
a server having data stored thereon;
a client device configured to communicate with said server over a network; and
a trust service module configured to detect an attempted execution of an application on said client device to access said data on said server and manage access of said data on said client device, said trust service module comprising:
a device recognition module configured to analyze said client device attempting to access said application and identify one or more characteristics of said client device and an associated user; and
a trust determination module configured to establish a level of trustworthiness of said client device based on said identified one or more characteristics and to determine said client device is authorized to execute said application and access said data of said server based on a comparison of level of trustworthiness of said client device with a predefined level of trust of said application.

10. The system of claim 9, wherein, if said level of trustworthiness is greater than or equal to said level of trust of said application, said trust determination module is configured to authorize and allow said client device to execute said application and access said data on said server.

11. The system of claim 9, wherein, if said level of trustworthiness is less than said level of trust of said application, said trust determination module is configured to prevent said client device from executing said application and accessing said data on said server.

12. The system of claim 9, wherein said one or more identified characteristics comprise client device attributes and user attributes.

13. The system of claim 12, wherein said client device attributes are selected from the group consisting of client device type, operating system (OS), media access control (MAC) address, international mobile station equipment identity (IMEI), universal device identifier (UDI), certificate status, encryption level by way of mobile device management (MDM) records and state of privileged escalation.

14. The system of claim 12, wherein said user attributes are selected from the group consisting of user identity, user credentials and user role.

15. The system of claim 9, wherein said client device is a personal electronic computing device and said application includes enterprise application software configured to provide said client device with access said data stored on said server, wherein said server is associated with a back end system of a business.

16. The system of claim 15, wherein said client device is selected from the group consisting of mobile telephone, smartphone, tablet computer, notebook computer, ultraportable computer, ultramobile computer and netbook computer.

17. At least one computer accessible medium storing instructions which, when executed by a machine, cause the machine to perform operations for managing secure access to an application and data provided by the application, said operations comprising:
detecting an attempted execution of an application on a client device;
identifying one or more characteristics of said client device and associated user of said client device;
determining a level of trustworthiness of said client device based on said identified characteristics of said client device and associated user;
identifying a predefined trust level associated with said application; and
comparing said level of trustworthiness of said client device with said trust level of said application and determining said client device is authorized to execute said application and access associated data based on said comparison.

18. The computer accessible medium of claim 17, further comprising:
permitting execution of said application on said client device and allowing access to associated data if said level of trustworthiness is greater than or equal to said level of trust of said application.

19. The computer accessible medium of claim 17, further comprising:
denying execution of said application on said client device and preventing access to associated data if said level of trustworthiness is less than said level of trust of said application.

20. A method for managing secure access to an application and data provided by the application, said method comprising:
detecting, by a trust service module, an attempted execution of an application on a client device;
identifying, by a device recognition module, one or more characteristics of said client device and associated user of said client device;
determining, by a trust determination module, a level of trustworthiness of said client device based on said identified characteristics of said client device and associated user;
identifying, by said trust service module, a predefined trust level associated with said application; and
comparing, by said trust determination module, said level of trustworthiness of said client device with said trust level of said application and determining said client device is authorized to execute said application and access associated data based on said comparison.

21. The method of claim 20, further comprising permitting execution of said application on said client device and allowing access to associated data if said level of trustworthiness is greater than or equal to said level of trust of said application.

22. The method of claim 20, further comprising denying execution of said application on said client device and preventing access to associated data if said level of trustworthiness is less than said level of trust of said application.

23. The method of claim 20, wherein said one or more identified characteristics comprise client device attributes and user attributes.

24. The method of claim 23, wherein said client device attributes are selected from the group consisting of client device type, operating system (OS), media access control (MAC) address, international mobile station equipment identity (IMEI), universal device identifier (UDI), certificate status, encryption level by way of mobile device management (MDM) records and state of privileged escalation.

25. The method of claim 23, wherein said user attributes are selected from the group consisting of user identity, user credentials and user role.
